(19) United States
(12) Patent Application Publication
(10) Pub. No.: US 2024/0347219 A1
(43) Pub. Date: Oct. 17, 2024

(54) Whispering gallery mode fusion reactor

(71) Applicant: Janos Dobos, Pecs (HU)

(72) Inventor: Janos Dobos, Pecs (HU)

(21) Appl. No.: 18/299,151

(22) Filed: Apr. 12, 2023

(51) Int. Cl. G21B 1/23; G21B 1/05

(52) U.S. Cl. CPC G21B 1/23; G21B 1/057

(57) ABSTRACT

The ultra-intense laser pulses circulating in the whispering gallery mode create periodically repeating inertial nuclear fusion in the center of the reactor space. The symmetry of the whispering gallery mode allows the plasma to stable shrink steadily. Another advantage of the whispering gallery mode is that, due to the angle of incidence-total reflection below ten degrees, higher intensity laser beams, X-rays, gamma rays, or even alpha, beta, neutron radiation can be used to compress the fusion material, since these radiations are also reflected whispering gallery operating mode from the inner mirror surface of the arc of the reactor space.

### FIELD OF THE INVENTION

This description generally relates to inertial fusion reactors and more specifically to indirect drive whispering gallery mode inertial fusion reactors.

### Background

On Dec. 5, 2022, a successful laser inertial confinement experiment was carried out at the Lawrence Livermore National Laboratory of the USA based on the patent No. WO2012064668A1 entitled “Indirect drive targets for fusion power”. The long-desired scientific breakthrough was realized, they were able to produce a larger amount of energy than the energy used for fusion excitation. From two sides, the focused energy of dozens of extremely powerful pulsed laser beams was directed around a small fusion fuel pellet (tritium, deuterium mixture) placed in the hohlraum, which indirectly compressed, heated, and then ignited the plasma by exciting X-rays.

The experiment is undoubtedly significant, but much work remains to be done. Due to the design of the system, the vanishing, scattered laser loss is still very high, the plasma is not a stable sphere, the insertion of fusion fuel is not continuous, the exploding capsule shell causes contamination and turbulence, cold external fuel mixes into the compressed fusion core.

Defense and aerospace company Lockheed Martin is developing a compact fusion reactor that can be transported by a truck and ships or planes, according to patent U.S. Pat. No. 9,934,876B2 entitled “Magnetic field plasma confinement for compact fusion power.” The solution is a magnetic trap in which optimized fusion confinement processes are formed. The solution is promising, but so far it has not been possible to produce more energy with it than is necessary for its operation.

Experiments are also being conducted with the magnetically confined fusion (aka tokamak) reactor, in which strong electromagnetic fields combine with electric current flowing directly through the plasma to heat and confine the toroidal plasma. The most ambitious of these is still the ITER project in the South of France. The biggest disadvantage of the solution is that imperfections in magnetic confinement lead to serious damage to the reactor, and there is no suitable solution to remove the large number of neutral atoms inside the reactor, making net energy production difficult.

In their article published in 2022 entitled “Nested mirror optics for neutron extraction, transport, and focusing” by Christoph Herb and his colleagues, they reported that they had achieved excellent results in the field of neutron transport with mirror reflection, in fact they repeated the discovery made by Fermi, according to which neutrons they are completely reflected from a nickel surface at a small angle.

In their publication “Generation of megatesla magnetic fields by intense-laser-driven microtube implosions” in 2020, M. Murakami and his colleagues used microtube implosion driven by ultra-intense laser pulses to produce ultra-high magnetic fields.

Due to the laser-produced hot electrons with energies of mega-electron volts, cold ions in the inner wall surface implode towards the central axis. The exploding ions and electrons produced a strong spin current density of peta-amperes and, as a result, a megatesla magnetic field through Larmor gyro-motion.

The published data of the first successful fusion experiment conducted by the Lawrence Livermore National Laboratory in the USA, as well as the research results of Christoph Herb and M. Murakami, inspired the inventors to create the present invention, which is a new technical solution, also industrially usable, can be built at low cost, and energy efficient.

Brief Summary of the Invention: One embodiment of the whispering gallery mode fusion reactor is a cavity similar to a rugby ball, on the curved inner mirror surface of which ultra-intense laser pulses circulating in the whispering gallery mode create inertial nuclear fusion. The invention is based on the combined application of three scientific findings.
In whispering gallery mode, the radiation circulates at an angle of incidence and total reflection below ten degrees, therefore-according to the research of Christoph Herb and Fermi-even high-power laser beams, X-rays, gamma rays, or even alpha, beta, neutron radiation can be circulated with little loss in the fusion reactor space of an axisymmetric, for example.
In rugby ball-like photonic bottle resonators, the whispering gallery-mode light beams at the thinner end of the bottle at a certain critical diameter, the turning point, turn back towards the thicker diameter of the bottle and then pass through it. After that, the light rays turn back towards the thicker diameter of the bottle at the other turning point. The light beams go back and forth in a whispering gallery mode between the two turning points. The same process can be replicated in the space of an axisymmetric, rugby-ball-shaped fusion reactor.
If a reactor space similar to a rugby ball is filled with fusion material, the whispering gallery mode radiation circulating back and forth between the critical diameters of the reactor space heats the fusion material located near the curved inner wall of the reactor space, whose high-energy hot particles explode symmetrically towards the central axis of the reactor space, they generate secondary X-ray radiation, the high-energy particles of which enclose the fusion material in a sphere, triggering the fusion reaction. (see published data of first successful fusion experiment conducted by Lawrence Livermore National Laboratory). The fusion process can be further assisted if the fusion material is biased with a kilotesla magnetic field, which in this case they even cause Larmor gyromotion, which causes a strong peta-amp current, whose megatesla magnetic field also helps to lock the fusion material into a sphere, triggering the fusion reaction. (see the research results of M. Murakami and his colleagues)

The invention is best understood with reference to the drawings.

### BRIEF DESCRIPTION OF DRAWINGS

FIG. 1. Schematic drawing of the arrangement of the whispering gallery mode fusion reactor.

FIG. 2. Schematic of the cross section of the whispering gallery mode fusion reactor.

FIG. 3. Schematic of the operating principle of the whispering gallery mode fusion reactor.

FIG. 4. Cross-sectional schematic drawing of the operating principle of the whispering gallery mode fusion reactor.

FIG. 5. Schematic drawing of the operating principle of the whispering gallery mode fusion reactor with magnetic field generators.

FIG. 6. Schematic drawing, which represents the return of part of the energy released in the fusion reaction to cause the next fusion reaction.

FIG. 7. Schematic drawing, which represents the torus-shaped reactor space.

### DETAILED DESCRIPTION OF INVENTION

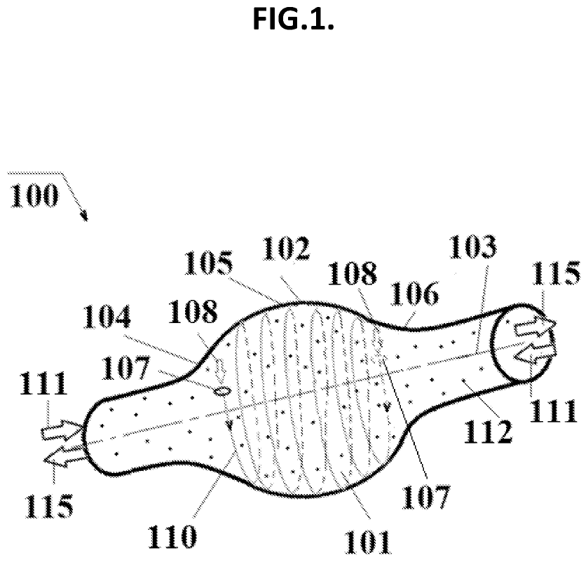

FIG. 1. based on the schematic drawing of the layout of the 100 whispering gallery mode fusion reactor, it can be determined that the layout of the present invention, the shape of the fusion reactor, is similar to the hohlraum shown in patent number WO2012064668A1. However, despite the similarity, the present invention differs significantly from the mentioned patent, as the present invention does not introduce the high-pulse laser beams opposite each other at the two ends of the reactor, but on the reactor mantle in a whispering gallery mode.

FIG. 1. according to the schematic drawing, one embodiment of the 100 whispering gallery mode fusion reactor includes a 101 reactor space with a 102 curved internal mirror surface, the diameter of which continuously increases along the 103 longitudinal axis starting from the 104 first input diameter of the reactor space, until it reaches the 105 maximum diameter of the reactor space, and then from there it is repeatedly reduced to the size of the 106 second input diameter of the reactor space.

FIG. 1. according to schematic drawing two 107 radiation input were placed in the 101 reactor space, one of which tangentially connected to the 104 first input diameter of the reactor space, and the other of which tangentially connected to 106 second input diameter of the reactor space, and they are configured in such a way that the incoming 108 radiation controlled by the neural network is guided onto the 102 curved internal mirror surface with an 109 incidence angle of less than ten degrees. The neural network control deliver the strength of incoming 108 radiation controlled by the neural network.

The incoming 108 radiation controlled by the neural network entering the 101 reactor space is transformed by the 102 curved internal mirror surface into 110 radiation circulating in whispering gallery propagating locally back and forth in the direction of the axis.

A 111 fusion material injector controlled by a neural network is connected 3elive 104 first input diameter of the reactor space and 106 second input diameter of the reactor space, which deliver the 112 fusion material into the 101 reactor space, and here the 115 releasable, freely usable fusion energy and fusion slag can be extracted and discharged. Freely usable fusion energy refers to the amount of energy that is not recycled to start the next fusion process, but can be energetically utilized. By fusion slag, we mean those slowed down particles and radiations that can no longer effectively help start the next fusion reaction, but can still be used energetically.

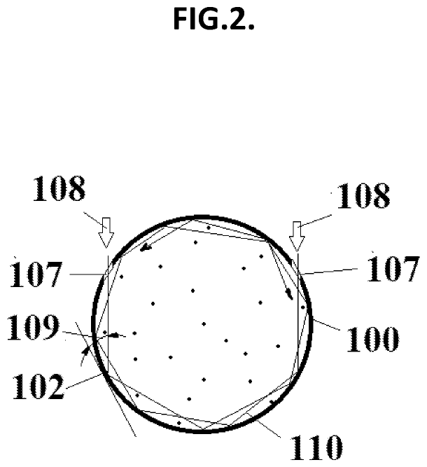

FIG. 2. schematic drawing of the cross-section of the 100 whispering gallery mode fusion reactor shows that the 108 radiation controlled by the neural network at the two 107 radiation inputs arrives at the 102 curved inner mirror surface with an 109 incidence angle of less than ten degrees, then continues 110 radiation circulating in whispering gallery mode, propagating locally back and forth in the direction of the axis.

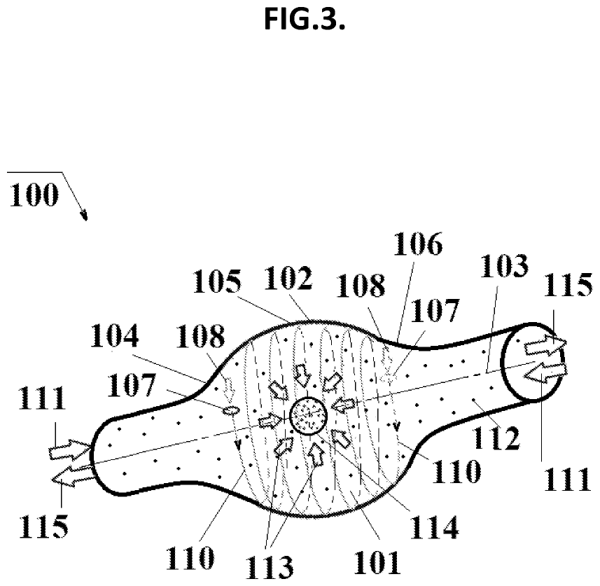

FIG. 3. based on the figure, it is easy to see that the present invention is capable of a significantly more efficient nuclear fusion process than the already mentioned successful experiment of the Lawrence Livermore National Laboratory in the USA. The reason for this is that in the whispering gallery mode there is no scattered radiation loss, as in the mentioned experiment, and due to the symmetry of the circular circulation, the compression is more symmetrical, therefore the plasma can be shrunk into stable sphere, so the fusion explosion is more efficient, and there is no capsule shell, which creates contamination and turbulence would cause, and the cold external fuel cannot mix into the compressed fusion core, as in the already mentioned patent No. WO2012064668A1.

FIG. 3. in the case of the embodiment according to the schematic drawing, in the 100 whispering gallery mode fusion reactor, the shrinking of the 112 fusion material by 113 secondary radiation into a 114 compressed fusion material, the collapse process is complex and consists of several stages.

The 107 radiation input formed on the surface of the 101 reactor space symmetrical along the 103 longitudinal axis, which are formed at the 104 first input diameter of the reactor space and at the 106 second input diameter of the reactor space, the incoming 108 radiation controlled by the neural network is directed to the 102 curved internal mirror surface, which transforms into a 110 radiation circulating in whispering gallery mode, propagating locally back and forth in the direction of the axis, and which also passes through 105 maximum diameter of the reactor space.

FIG. 3. in the case of the embodiment according to the schematic drawing, the high-intensity 110 radiation circulating in whispering gallery mode, propagating locally back and forth in the direction of the axis, heats to a high temperature the 102 curved internal mirror surface and the 112 fusion material around it, which was injected by 111 fusion material injector controlled by a neural network into the 101 reactor space. The heated 112 fusion material emits 113 secondary radiation, typically X-rays and gamma rays. By definition, the 113 secondary radiation spreads towards the colder center defined by the intersection of the 103 longitudinal axis and the 105 maximum diameter of the reactor space in the middle of the reactor space.

The propagation towards the center is symmetrical due to the symmetry of the 101 reactor space and the symmetry of the 110 radiation circulating in whispering gallery mode, propagating locally back and forth in the direction of the axis.

The 112 fusion material shrinks in a sphere under the pressure of 113 secondary radiation, typically X-rays and gamma rays.

The 114 compressed fusion material is compressed into a ball with a density 100 times that of lead and a temperature of 50 million degrees Celsius.

According to the simulation, in 114 compressed fusion material, fusion burning starts in the center of the sphere. With the present invention, there is a way to divert and use the 115 releasable, freely usable fusion energy and fusion slag for energetic purposes.

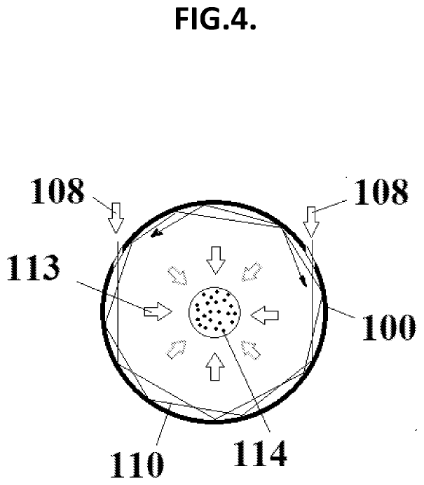

FIG. 4. the cross-sectional schematic diagram of the operating principle of the 100 whispering gallery fusion reactor shows that the 110 radiation circulating in whispering gallery mode, propagating locally back and forth in the direction of the axis created from 108 radiation controlled by the neural network, generates 113 secondary radiation, which shrinks the 114 compacted fusion material circularly symmetrically.

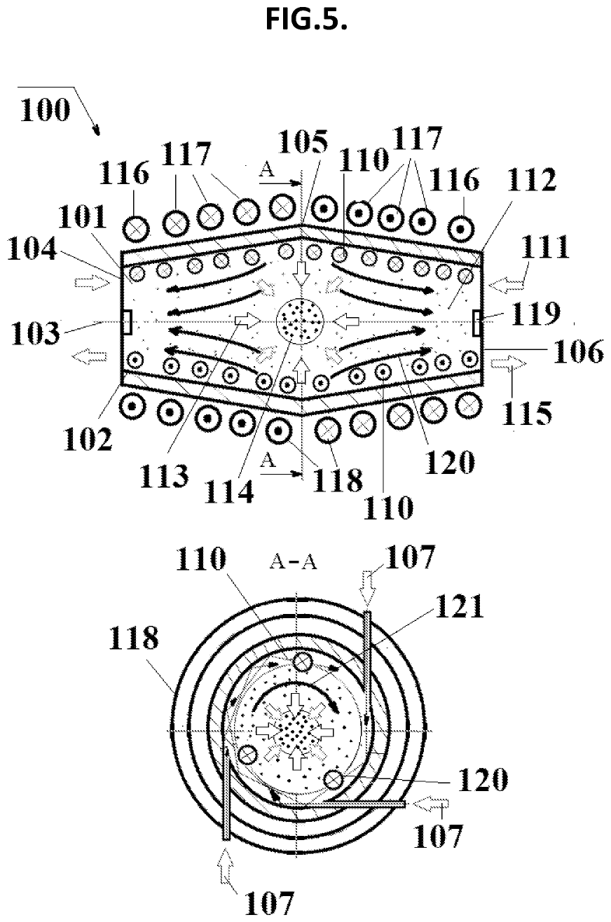

FIG. 5. schematic drawing of the principle of operation of a 100 whispering gallery mode fusion reactor with magnetic field generators depicts how magnetic fields can support the nuclear fusion process.

FIG. 5. according to the embodiment shown in fig., the 100 whispering gallery mode fusion reactor, the 101 reactor space, the 102 curved internal mirror surface around we place two 116 neural network controlled, toroid-shaped plasma flow closing magnetic field generator, one of which is the 104 first input diameter of the reactor space, while the other one is placed near the 106 second input diameter of the 101 reactor space arranged coaxially with the 103 longitudinal axis, we also place six 117 neural network controlled, toroidal fusion material separator magnetic field generators, three of which are between the 104 first input diameter of the reactor space and the 105 maximum diameter of the reactor space, while the other three of which are between the 106 second input diameter of the 101 reactor space and 105 maximum diameter of the reactor space, arranged coaxially around the reactor space with respect to the 103 longitudinal axis, we also place two 118 neural network controlled, encapsulating magnetic field generators, which were placed near the 105 maximum diameter of the reactor space, arranged coaxially around the 101 reactor space to the 103 longitudinal axis.

By neural control we mean that a neural computer network regulates the strength and direction of the 120 magnetic field created by the magnetic field generators according to the needs of the fusion processes.

The reactor space is biased with kilotesla strength 120 magnetic fields. The 107 radiation input formed on the surface of the 101 reactor space symmetrical along the 103 longitudinal axis, which are formed at the 104 first input diameter of the reactor space and at the 106 second input diameter of the reactor space, the incoming 108 radiation controlled by the neural network is directed to the 102 curved internal mirror surface, which transforms into a 110 radiation circulating in whispering gallery mode, propagating locally back and forth in the direction of the axis, and which also passes through 105 maximum diameter of the reactor space.

The high-intensity 110 radiation circulating in whispering gallery mode, propagating locally back and forth in the direction of the axis, heats to a high temperature the 102 curved internal mirror surface and the 112 fusion material around it, which was injected by 111 fusion material injector controlled by a neural network into the 101 reactor space.

The heated 112 fusion material emits 113 secondary radiation, typically X-rays and gamma rays. By definition, the 113 secondary radiation spreads symmetrically towards the colder center defined by the intersection of the 103 longitudinal axis and the 105 maximum diameter of the reactor space in the middle of the reactor space. The 112 fusion material condenses in a sphere under the pressure of 113 secondary radiation, typically X-rays and gamma rays.

The fusion process was controlled by the two 116 neural network controlled, toroid-shaped plasma flow closing magnetic field generator helps by narrowing the flow of the fusion material at the 104 first input diameter of the 106 second input diameter of the reactor space. The six 117 neural network controlled, toroidal fusion material separator magnetic field generator and two 118 neural network controlled, encapsulating magnetic field generator promote the symmetrical compression of the fusion material, which can be called encapsulation, through the shape of the magnetic field they generate. In order to facilitate fusion processes 119 emitter materials can also be placed in the reactor space, for example with lithium content or boron11 content.

The moving particles of the 112 fusion material biased in the 120 magnetic field generate a current, which is why the Lorenz force acts on them. Since the Lorenz force is perpendicular to the 120 magnetic field and the direction of the current, the plasma is rotated by the Lorenz force. The 121 rotating plasma further increases the symmetrical compression of the fusion material.

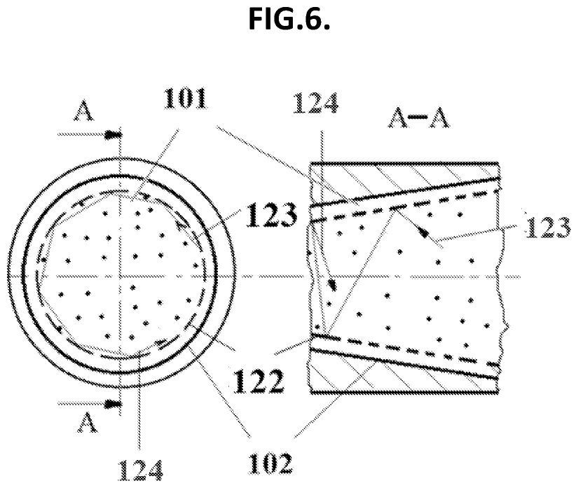

FIG. 6. schematically, the drawing shows that the part of radiation from the fusion explosion can be returned to ensure the energy demand of the next fusion by means of a 122 plasma mirror separated from the 102 curved internal mirror surface by magnetic fields. In the 122 plasma mirror shaped like a rugby ball, some of the particles propagate in 123 whispering gallery mode in the 122 plasma mirror's captivity. The 123 whispering gallery-mode particles at the thinner end of the 122 plasma mirror at a certain critical diameter, the turning point, turn 124 back towards the thicker diameter of the plasma mirror. After that, the light rays turn back towards the thicker diameter of the plasma at the other turning point. The light beams go back and forth in a whispering gallery mode between the two turning points (this is not shown in the drawing) and participate in the next fusion process.

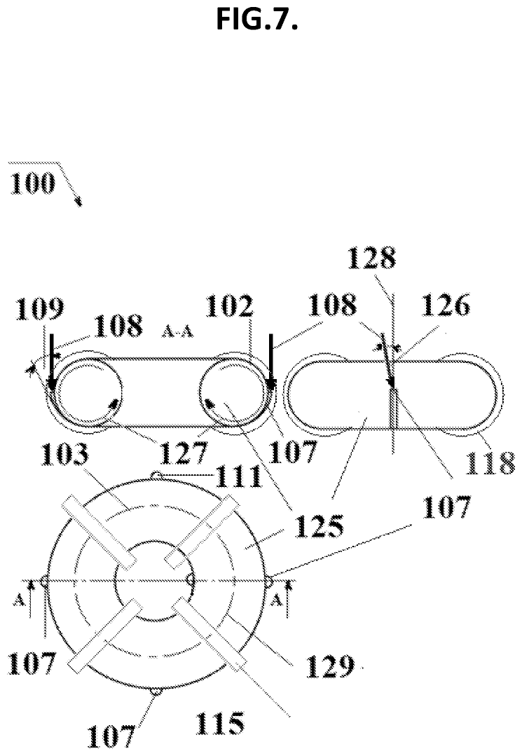

FIG. 7. Figure schematically shows the 125 torus-shaped reactor space with a 102 curved internal mirror surface. The 100 whispering gallery mode fusion reactor characterized in that it comprises: at least one 107 radiation input which is configured in such a way that the incoming 108 radiation controlled by the neural network is directed onto the 102 curved internal mirror surface with an 109 incidence angle of less than ten degrees, at least one at least one 127 whispering gallery mode radiation that follows the geometry of the torus and which is a continuation of 108 radiation controlled by the neural network.

In order for the whispering gallery mode to be continuous in the direction of the 129 torus axis, the incoming radiation is brought into the space of the torus reactor with a deviation of at least ten degrees from the 128 perpendicular.

At least four 118 neural network controlled, encapsulating magnetic field generators promote the symmetrical compression of the fusion material.

The ultra-intense laser pulses circulating in the whispering gallery mode create periodically repeating inertial nuclear fusion in the center of the reactor space.

It is possible to introduce the fusion material on the outer shell of the torus, with the help of the 111 fusion material injector controlled by a neural network, and also to discharge the 115 releasable, freely usable fusion energy and fusion slag on the inner shell of the torus.

The described embodiments are to be considered in all respects only as illustrative and not restrictive. The scope of the disclosure is, therefore, indicated by the appended claims rather than by the foregoing description.

1. Whispering gallery mode fusion reactor (100) characterized in that it comprising:
a reactor space (101) with a curved internal mirror surface (102), the diameter of which continuously increases along the longitudinal axis (103) from the first input diameter of the reactor space (104), not yet reaching the maximum diameter of the reactor space (105) that then from there its diameter should continuously decrease to the size of the second input diameter of the reactor space (106),
at least one radiation input (107), which is connected to the first input diameter of the reactor space (104), or to the second input diameter of the reactor space (106), or to both which is configured in such a way that the incoming radiation controlled by the neural network (108) is directed onto the curved internal mirror surface (102) with an incidence angle of less than ten degrees (109),
at least one radiation circulating in whispering gallery mode, propagating locally back and forth in the direction of the axis (110), which is a continuation of radiation controlled by the neural network (108).

2. Whispering gallery mode fusion reactor (100) characterized in that it comprising:
a reactor space (101) with a curved internal mirror surface (102), the diameter of which continuously increases along the longitudinal axis (103) from the first input diameter of the reactor space (104), not yet reaching the maximum diameter of the reactor space (105) that then from there its diameter should continuously decrease to the size of the second input diameter of the reactor space (106),
at least one radiation input (107), which is connected to the first input diameter of the reactor space (104), or to the second input diameter of the reactor space (106), or to both which is configured in such a way that the incoming radiation controlled by the neural network (108) is directed onto the curved internal mirror surface (102) with an incidence angle of less than ten degrees (109),
at least one radiation circulating in whispering gallery mode, propagating locally back and forth in the direction of the axis (110), which is a continuation of radiation controlled by the neural network (108),
at least two neural network controlled, toroid-shaped plasma flow closing magnetic field generator (116),
at least two neural network controlled, toroidal fusion material separator magnetic field generator (117),
at least two neural network controlled, encapsulating magnetic field generator (118).

3. Whispering gallery mode fusion reactor (100) characterized in that it comprising:
a torus-shaped reactor space (125) with a curved internal mirror surface (102),
at least one radiation input (107) which is configured in such a way that the incoming radiation controlled by the neural network (108) is directed onto the curved internal mirror surface (102) with an incidence angle of less than ten degrees (109),
at least one whispering gallery mode radiation that follows the geometry of the torus (127) and which is a continuation of radiation controlled by the neural network (108),
at least four neural network controlled, encapsulating magnetic field generators (118).
